(19) United States
(12) Patent Application Publication
(10) Pub. No.: US 2016/0186817 A1
(43) Pub. Date: Jun. 30, 2016

(54) FRICTION COUPLING

(71) Applicant: AKTIEBOLAGET SKF, Göteborg (SE)

(72) Inventors: Yuri KADIN, Neuwegein (NL); Bo HAN, Nieuwegein (NL)

(73) Assignee: Aktiebolaget SKF, Göteborg (SE)

(21) Appl. No.: 14/911,272

(22) PCT Filed: Sep. 11, 2013
(86) PCT No.: PCT/EP2013/068809

§ 371 Date: Feb. 10, 2016

(51) Int. Cl. F16D 7/02; G01N 19/02; G01N 3/44

(52) U.S. Cl. CPC F16D 7/025; G01N 3/44; G01N 19/02

(57) ABSTRACT

A friction coupling comprising first and second coupling surfaces. A friction surface is provided on the first coupling surface and a counterface is provided on the second coupling surface. The friction coupling further comprises preload elements, such as bolts, for applying a predefined pressure on the first and second coupling surfaces. The friction surface of the coupling comprises abrasive particles that constitute hard asperities which protrude from a substrate of the friction surface with a height h. The abrasive particles are provided on the substrate in a predefined asperity density η. The predefined asperity density η is greater than a minimum threshold for the asperity density ηₘᵢₙ and is less than 2.5*ηₘᵢₙ. The minimum threshold is defined by the following relationship:

$${η}_{min} = \frac{π}{4} \frac{P}{H} \frac{{μ}_{abr}^{2}}{{\overline{h}}^{2} + {σ}^{2}}$$

where
η asperities per unit (surface area) (m⁻²);
P pressure (Pa);
μ_{abr} coefficient of friction;
H hardness (counterface) (Pa)
h̅ height (asperities) (m);
σ standard deviation (asperity heights) (m).

### CROSS REFERENCE TO RELATED APPLICATION

This is a United States National Stage Application claiming the benefit of International Application Number PCT/EP2013/068809 filed on 11 Sep. 2013 (11.09.2013), which is incorporated herein by reference in its entirety.

### FIELD OF THE INVENTION

The present invention relates to the field of torque-transfer couplings based on the principle of friction between materials. More particularly, the invention is directed to a friction coupling comprising a friction surface that is provided with embedded abrasive particles. The invention is further directed to a method of determining whether a friction coupling will provide sufficient friction torque under specific application conditions.

### BACKGROUND TO THE INVENTION

A friction coupling of the above kind is disclosed in EP 2075466. The coupling concerns a connection between a low speed main shaft of a wind turbine and an input shaft of a transmission gearbox. The main shaft and input shaft have opposing connection surfaces which are pressed together by pre-tensioning means, such that a permanent load is applied on the connection surfaces. Further, friction enhancing means are provided between the connection surfaces in the form of a coating comprising grains of diamond. In a preferred embodiment, the coating is provided on a shim or disk that is placed between the connection surfaces.

An advantage of connecting a wind turbine main shaft and a transmission input shaft in this manner is that the friction-enhancing coating greatly increases the friction coefficient between the connection surfaces. As a result, the required torque can be transferred through the connection, while enabling the dimensions of the connection to be relatively compact. A disadvantage of using diamond grains in the friction-enhancing coating is that the coating is necessarily expensive.

Consequently, there is room for improvement.

### SUMMARY OF THE INVENTION

It is an aim of the present invention to define a friction coupling comprising a friction surface with abrasive particles in which the abrasive particles are provided in a density that is optimised for a known application pressure.

Specifically, the invention resides in a friction coupling comprising first and second coupling surfaces, wherein a friction surface is provided on the first coupling surface and a counterface is provided on the second coupling surface. The friction coupling further comprises preload means such as bolts for applying a predefined pressure on the first and second coupling surfaces. The friction surface comprises abrasive particles that constitute hard asperities which protrude from a substrate of the friction surface with a height h. According to the invention, the abrasive particles are embedded in the substrate according to a predefined asperity density q. The predefined asperity density η is greater than a minimum threshold for the asperity density ηₘᵢₙ and is less than 2.5*ηₘᵢₙ. The minimum threshold is defined by the following relationship:

$${η}_{min} = \frac{π}{4} \frac{P}{H} \frac{{μ}_{abr}^{2}}{{\overline{h}}^{2} + {σ}^{2}}$$

where
η represents number of asperities per unit surface area of the friction surface (m⁻²);
P represents the predefined pressure (Pa);
μ_{abr} represents a coefficient of abrasive friction between the friction surface and the counterface (dimensionless);
H represents a hardness of the counterface (Pa)
h̅ is a mean height of the asperities (m);
σ is the standard deviation of asperity heights (m).

The invention is based on the understanding that a critical pressure exists at which the friction coefficient between the friction surface and the counterface ceases to be governed by the high abrasive friction coefficient. When the critical pressure is exceeded, adhesive friction becomes the dominant friction mechanism, which has a lower friction coefficient than abrasive friction. The present inventors have developed a model for determining the critical pressure in a friction coupling of the kind defined above. The model is used to determine the asperity density at which the critical pressure is reached. If the predefined pressure P in a given application is assumed to equal the critical pressure, then the corresponding asperity density is the minimum threshold for the asperity density ηₘᵢₙ.

At asperity densities greater than the minimum threshold, the high coefficient of abrasive friction between the counterface and the friction surface is ensured. In known friction couplings, abrasive particles are embedded in the friction surface in as high a density as possible, governed by the size of the asperities. In a friction coupling according to the invention, more economical use is made of the abrasive particles. The friction surface has an asperity density η that is adapted for the known application pressure. Suitably, a safety factor X is employed, whereby η=X*ηₘᵢₙ. In some examples, the safety factor X has a value of between 1.2 and 2.5. In other examples, the safety factor X has a value of between 1.5 and 2.0.

The friction surface is suitably formed by a coating comprising a metal bond layer in which the abrasive particles are embedded. In a preferred example, the metal bond later comprises Nickel and the abrasive particles comprise diamond particles or synthetic diamond particles.

The friction surface may be applied directly on the first coupling surface of the friction coupling. Alternatively, the friction surface is provided on at least one face of an annular friction disk that is mounted to the first coupling surface. In a preferred example, the annular friction disk is formed from a plurality of segments, whereby each segment has a friction surface.

According to a second aspect, the invention provides a method of determining if a friction coupling comprising an abrasive friction surface and a counterface will be capable of delivering a desired level of torque transfer when subjected to a predefined operating pressure P. The friction surface comprises hard asperities which protrude from the friction surface with a height h; the counterface has a hardness H.

The method comprising steps of:

determining an abrasive coefficient of friction μ_{abr} between the friction surface and the counterface;
a) determining the hardness H of the counterface;
b) measuring a mean height h̅ of the asperities on at least part of the friction surface;
c) measuring an asperity density η of at least part of the friction surface;
d) determining that the friction coupling is capable of delivering the desired level of torque transfer if η>ηₘᵢₙ, whereby

$${η}_{min} = \frac{π}{4} \frac{P}{H} \frac{{μ}_{abr}^{2}}{{\overline{h}}^{2} + {σ}^{2}}$$

Preferably, the step of determining e) comprises determining that the friction coupling is capable of delivering the desired level of torque transfer if η>X*ηₘᵢₙ, whereby X is a safely factor. The safety factor has a value of between 1.2 and 2.5.

In one embodiment of the method, the step of determining b) comprises measuring a Rockwell C hardness or equivalent hardness of the counterface.

In an alternative embodiment, the step of determining b) comprises calculating the hardness of the counterface according to the following formula:

$$H = \frac{2}{3} Y ( 1 + ln \frac{π E {μ}_{abr}}{6 ( 1 - {v}^{2} ) Y} )$$

where
Y is the yield stress of the counterface (MPa)
E is the elastic modulus of the counterface (Pa) and
v is the Poisson ratio of the counterface.

Thus, the understanding behind the present invention may be used in quality control procedures for manufactured friction surfaces, and may be used to design friction couplings for specific applications, which are less expensive than known friction couplings, yet perform just as well. These and other advantages will become apparent from the following detailed description and accompanying figures.

### BRIEF DESCRIPTION OF THE DRAWINGS

The invention will now be described further, with reference to the following Figures, in which:

FIG. 1 schematically represents a side view of a typical wind turbine in which an example of a friction coupling according to the present invention is integrated;

FIG. 2 is an exploded cross-section view of sub-assembly of the wind turbine from FIG. 1, which sub-assembly comprises the inventive friction coupling;

FIGS. 3a & 3b show a front view of examples of a friction disk that may be used in a friction coupling according to the invention;

FIG. 3c shows a detail of a friction surface on the example friction disks of FIGS. 3a and 3b;

FIGS. 4a & 4c respectively show first and second examples of an abrasive friction interface, under an applied normal force at which asperities of the abrasive friction interface take up the full force;

FIGS. 4b & 4d respectively show the first and second interfaces under a critical normal force at which all of the asperities are indented in a counterface of the interface with a depth equal to the height of the asperity;

FIG. 5 is a graph of friction force against applied normal force for the first and second abrasive friction interfaces.

### DETAILED DESCRIPTION OF THE PRESENT INVENTION

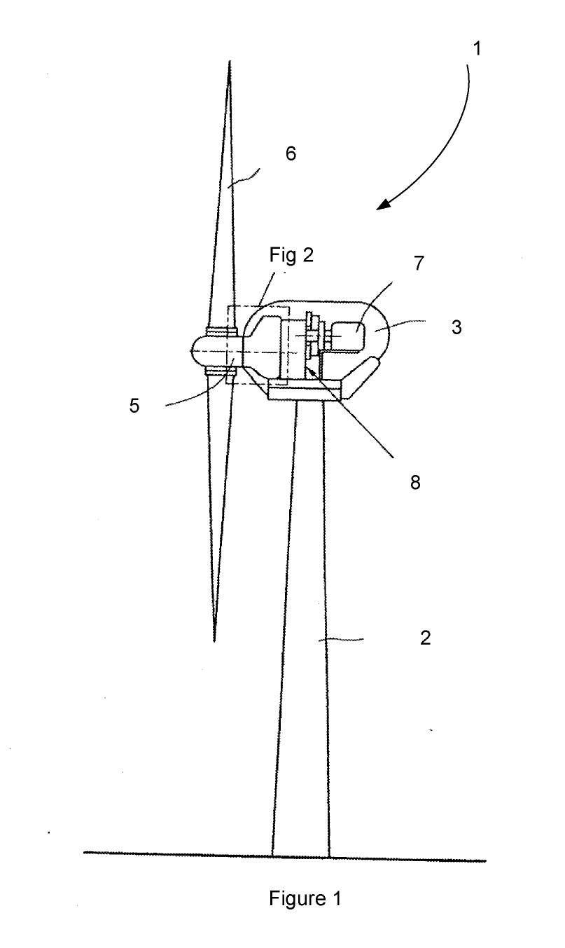

A typical wind turbine 1 as shown in FIG. 1 comprises a tower structure 2 on which a nacelle 3 is mounted so as to be rotatable around a vertical axis, enabling the position of the nacelle to be adjusted depending on the wind direction. In the nacelle 3 a rotor with a rotor hub 5 is provided, whereby the rotor hub 5 is connected to an electrical power generator 7 through a transmission gearbox 8. Rotor blades 6 are attached to the rotor hub 5, for driving the hub and generator by wind power.

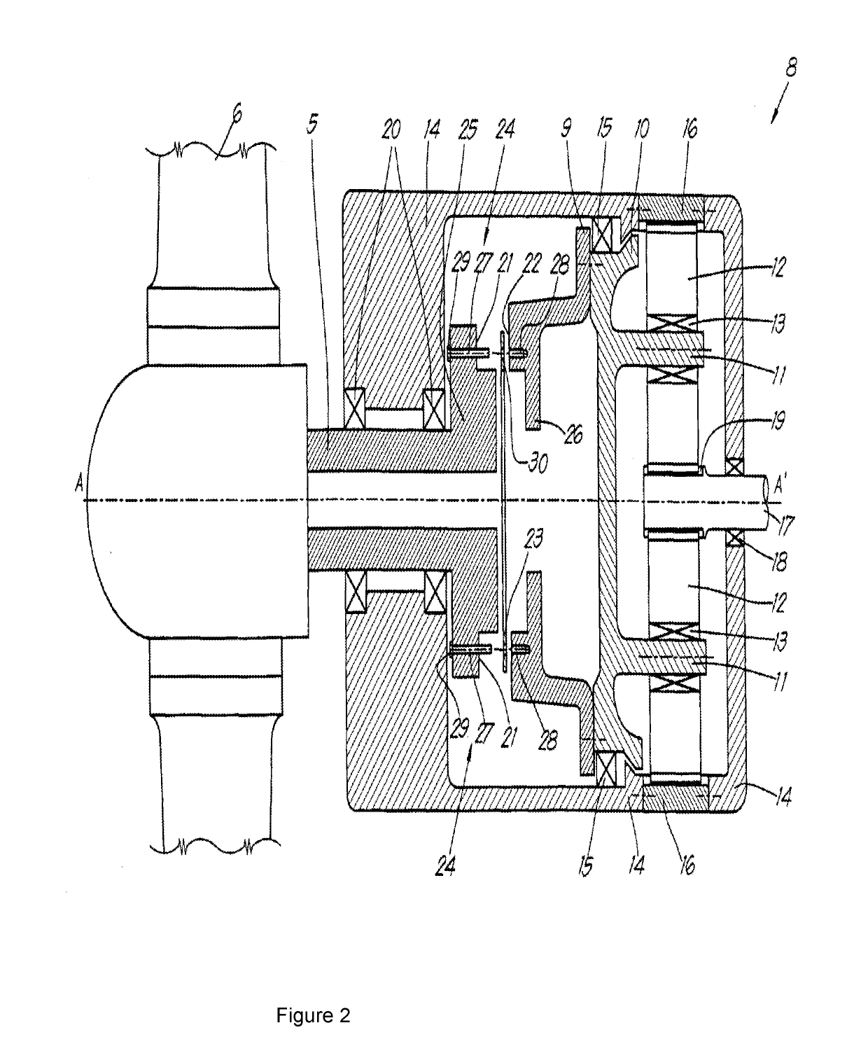

As is shown in exploded view of FIG. 2, the gearbox 8 contains in this case a planetary gear stage. An input shaft 9 of the gearbox 8 is mounted on the planet carrier 10 of the planetary gear stage. The planet carrier 10 has planet shafts 11 on which planet wheels 12 are rotatably mounted by means of planet bearings 13. The planet carrier 10 is also rotatably mounted with regard to a housing 14 of the gearbox 8 by means of planet carrier bearings 15. Further, a ring wheel 16 is fixedly mounted in the housing 14 via bolts or other connection means.

An output shaft 17 of the gearbox 8 is connected to the generator 7 (refer FIG. 1) by means of output shaft bearings 18. Furthermore, the output shaft 17 is provided with a sun wheel 19. The interaction of the planet wheels 12 with the ring wheel 16 and with the sun wheel 19 transforms the slow rotation of the planet carrier 10 and input shaft 9 into a fast rotation of the output shaft 17. Hence, when applied in a wind turbine 1, the slow rotation of the rotor blades 6 is transformed into a sufficiently fast rotation at the output shaft 17 of the gearbox 8 for a proper functioning of the electrical power generator 7.

The rotor hub 5 is rotationally supported in the housing 14 by means of rotor bearings 20, whereby the rotor hub 5 represents the slow speed main shaft 5 of the wind turbine 1. A coupling between the rotor hub 5 or the slow speed main shaft 5 and the input shaft 9 of the transmission gearbox 8 is needed to enable torque transfer from the rotor blades 6 to the output shaft 17. This is achieved by means of a friction coupling. The coupling comprises a first coupling surface 21 on the low speed main shaft 5 and a second coupling surface 22 on the input shaft 9 of the gearbox 8. The first coupling surface 21 is provided on a flange part 25 of the main shaft 5 and the second coupling surface is provided on a collar 26 that is connected to the output shaft 17. Further, a friction disk 23 comprising a friction surface with abrasive particles is mounted between the coupling surfaces 21, 22. The coupling surfaces are additionally connected by means of bolts or other suitable preload means, which apply a permanent load on the coupling surfaces 21, 22. The frictional force generated between the coupling surfaces enhances the torque-transfer capability of the coupling as a whole. This enables the dimensions of the flange 25 and collar 26 to be more compact and lightweight than if the coupling consisted only of bolt connections.

In the example depicted in FIG. 2, the flange 25 and the collar 26 are complementarily shaped, whereby the flange 25 is a male part and the collar is a female part. Further, holes 27 are provided in the flange 25, which holes are distributed evenly around the circumference of the flange 25. Threaded holes 28 are correspondingly provided in the collar 26 for receiving the bolts 29. Preferably, the friction disk 23 is also provided with holes 30, so that the bolts 29 also can pass through the friction disk 23. This accurately locates the friction disk and prevents it from rotating relative to the first and second surfaces 21, 22.

The bolts 29 and holes 27 and 28 form preload means 24 which apply a permanent pressure on the first and second coupling surfaces 21 22.

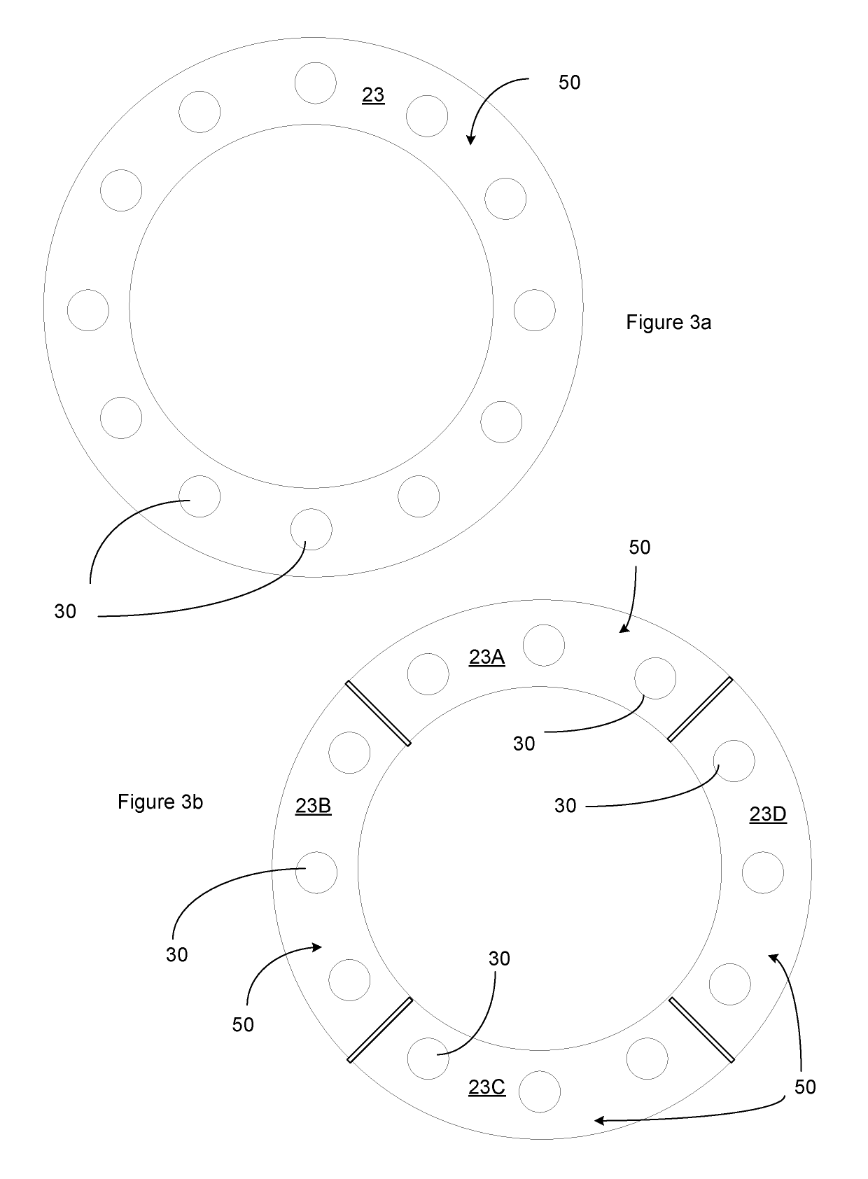

A front view of the friction disk 23 is shown in FIG. 3a. The disk is a continuous annular component comprising connection holes 30 and a friction surface 50. An alternative example of a friction disk is shown in FIG. 3b. In this example, the disk is formed from a number of arcuate segments 23A, 23B, 23C, 23D, whereby each segment has a friction surface 50 and connection holes 30. The friction surface is formed from a coating comprising abrasive particles in a metal bond layer. In a preferred embodiment, the coating comprises diamond particles or synthetic diamond particles in a Nickel bond layer.

An exploded view of a section of the friction surface 50 is shown in FIG. 3c. Abrasive particles 51 (diamond particles in this example) form asperities that protrude from the bond layer substrate 53 with a certain asperity height h. Further, the particles 51 are distributed on the substrate 53 with a certain asperity density η which is a number of individual asperities per unit surface area. In use of the friction coupling, the hard abrasive particles 51 are pressed into a counterface. In the example of FIG. 2, the counterface is formed by the second coupling surface 22 on the collar 26, which is made of cast iron. The friction surface 50 is provided on the first coupling surface 21 on the flange 25, via the friction disk 23. It also possible to apply the friction surface directly onto the first coupling surface 21.

Under the applied preload between the coupling surfaces, the asperities make indentations in the counterface 22, which generates a “ploughing” effect when the friction surface is torqued. The predominant friction mechanism is abrasive friction, and torque transfer is maximized when the friction coupling has a high coefficient of abrasive friction μ_{abr}.

In a friction coupling according to the invention, the friction surface 50 has a predefined asperity density which is optimized for the application conditions. A high abrasive friction coefficient is ensured, while economic use is made of the expensive abrasive particles.

More specifically, the invention is based on defining a minimum asperity density at which, under a given pressure P applied on the coupling surfaces, the high abrasive friction coefficient is obtained.

Friction coefficient is an interface property between two surfaces, which does not depend on the applied force or pressure. The frictional force F_{T} that is generated does depend on the applied normal force F_{N} according to the following well-known formula:

F_{T}=μ*F_{N}.

Abrasive friction coefficient μ_{abr} is governed by a sharpness angle of the asperities and not by their size or height, or by the asperity density. The present invention is based on the understanding that a critical pressure exists at which the abrasive friction ceases to be the dominant friction mechanism, and at which the coefficient of friction drops. This critical pressure is dependent on asperity density and on asperity geometry.

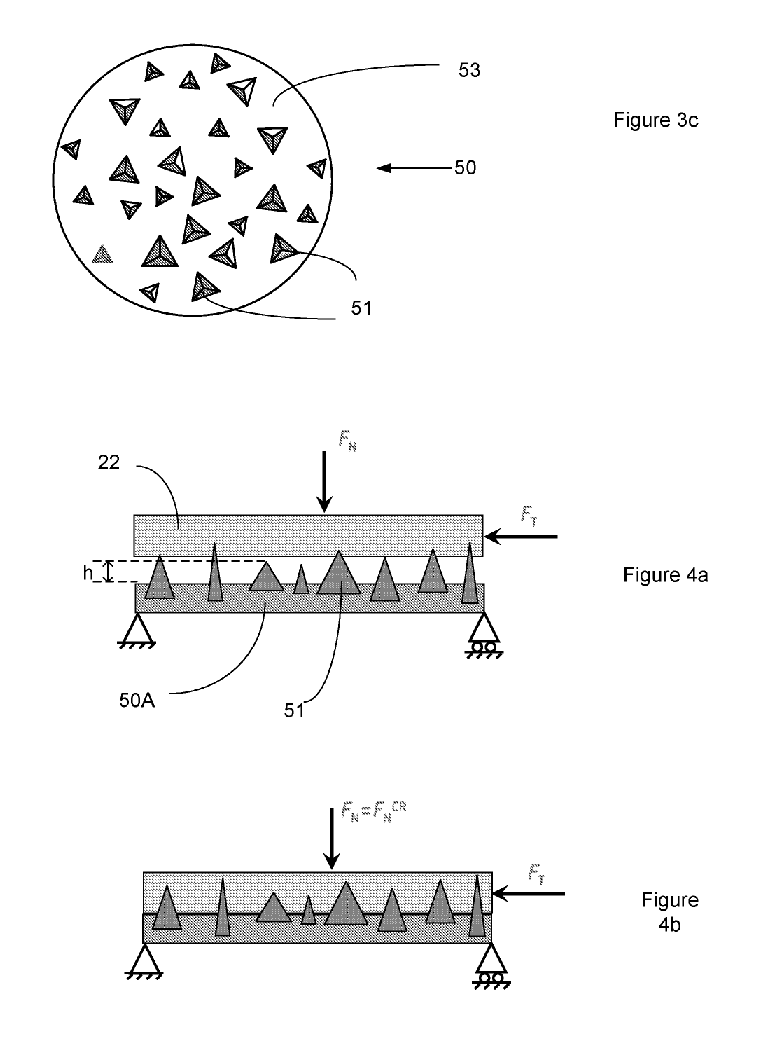

FIGS. 4a and 4b show a schematic representation of a first friction interface comprising an abrasive friction surface 50A and a counterface 22. The friction surface has hard asperities 51 that protrude from the surface 50A with a certain height h. The height of only one asperity is depicted so as not to obscure the drawing. In FIG. 4a, a normal force F_{N} is applied, which force is less than a critical normal force F_{N}^{CR}. The normal force F_{N} is entirely taken up by the hard asperities 51, which provide high abrasive friction due to ploughing and thus good grip between the surfaces.

When the applied normal force increases to a certain critical value F_{N}^{CR}, as shown in FIG. 4b, all the hard asperities become embedded in the counterface 22 with a depth equal to their height h. In other words, the normal force is no longer taken up by the hard asperities 51 and metal-to-metal contact occurs. The dominant friction mechanism becomes adhesive friction, and the coefficient of adhesive friction is typically much lower.

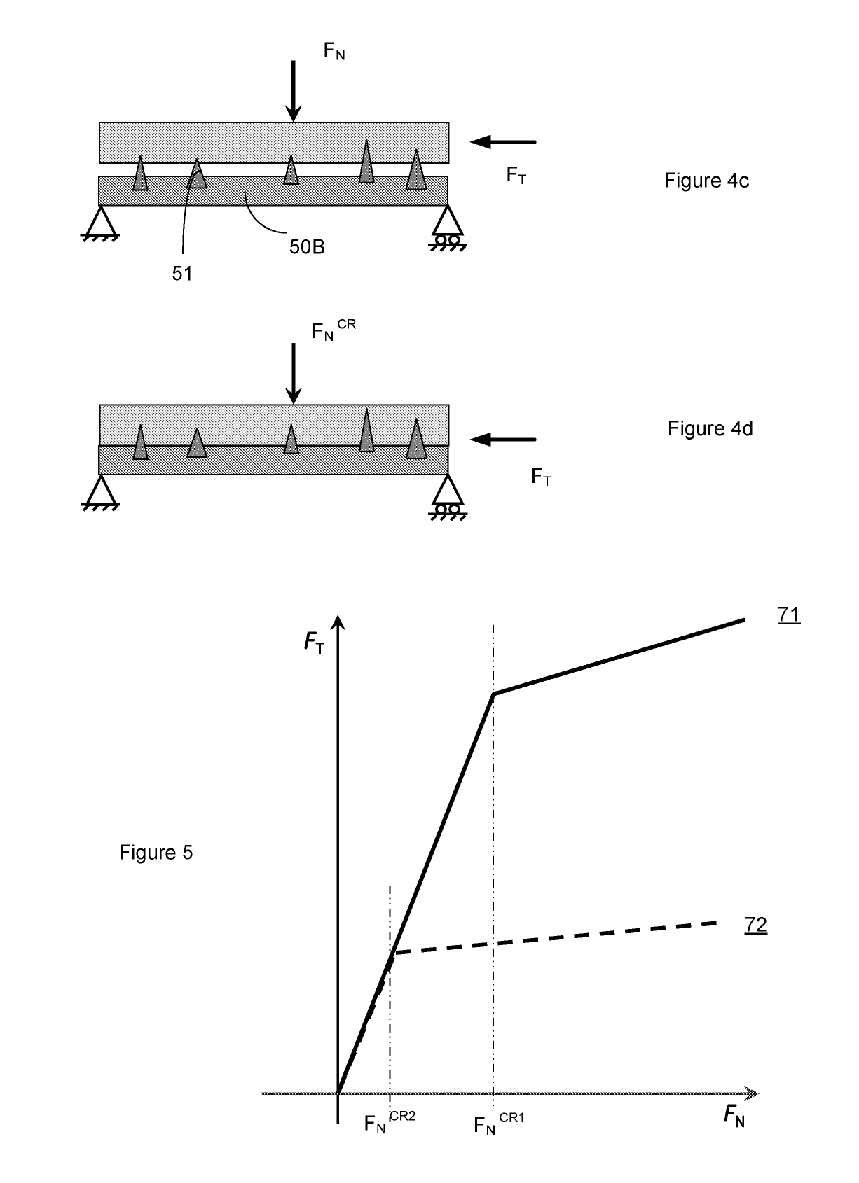

The effect can be seen in FIG. 5, which shows a graph of resultant frictional force F_{T} against applied normal force F_{N}. A first line 71 represents the first friction interface and two distinct regions can be observed. Initially, the line 71 has a steep gradient whereby the friction coefficient is substantially equal to μ_{abr}. Then, after the critical force F_{N}^{CR1} has been exceeded, the gradient of the first line 71 becomes much less steep and the coefficient of friction is significantly less than μ_{abr}.

FIGS. 4c and 4d show a schematic representation of a second friction interface comprising an abrasive friction surface 50B and a counterface 22. The only difference between the first and second examples is that the friction surface 50B has a lower asperity density than the friction surface 50A. The individual asperities 51 in the friction surface 50B have the same sharpness angle.

FIGS. 4c and 4d respectively show the second interface when a normal force less than the critical force is applied and when a normal force equal to the critical force is applied. The resultant frictional force F_{T} plotted against applied normal force F_{N} is represented by the second line 72 in the graph of FIG. 5. Again the second line 72 has two distinct regions in which a steep gradient and a shallow gradient are observed.

In the steep region, the gradient of the second line 72 is equal to that of the first line 71. The asperities 51 on the friction surfaces of both examples 50A and 50B have the same sharpness angle and thus initially have the same coefficient of abrasive friction μ_{abr}. Then, at a certain critical value of the applied normal force F_{N}^{CR2}, which is less than F_{N}^{CR1}, the friction coefficient drops.

The present inventors have developed a model for determining the critical normal force and associated critical pressure for an abrasive friction interface. Therefore, when the pressure in a friction coupling application is known, such as in a coupling according to the invention where e.g. bolted connections provide a known preload, it is possible to a calculate a minimum asperity density for that application above which the high abrasive coefficient of friction is ensured.

The minimum asperity density ηₘᵢₙ may be calculated as follows:

$${η}_{min} = \frac{π}{4} \frac{P}{H} \frac{{μ}_{abr}^{2}}{{\overline{h}}^{2} + {σ}^{2}} \qquad [ equation 1 ]$$

whereby
P is the applied pressure (in MPa)
μ_{abr} is the coefficient of abrasive friction (dimensionless)
H is the hardness of the counterface material (in MPa)
h̅ is the mean height of the asperities (m)
σ is the standard deviation of asperity heights (m)

In a friction coupling according to the invention, the friction surface has an asperity density η which is greater than ηₘᵢₙ and no more than ηₘᵢₙ*2.5. Even at the upper end of this range, the asperity density in a friction coupling according to the invention is significantly less than in known friction couplings.

### EXAMPLE

A commercially available friction coupling of the kind described with reference to FIGS. 1 and 2 was examined. The friction surface of the friction disk 23 consisted of diamond particles in a Nickel bond later. The asperity density and mean asperity height of the friction surface were measured by scanning a region of the friction surface using a laser scanning microscope. The measured asperity density was 313 asperities per mm² and the measured mean asperity height was 21.7 μm. The measured standard deviation was 9 μm.

The material of the counterface was cast iron. The coefficient of friction between the friction surface and the counterface was measured using a conventional test method as described in ASTM D1894. A value of 0.75 was measured. The frictional force measured during the test is representative of the total friction, which consists of abrasive friction and adhesive friction. The abrasive friction is due to the hard asperities which plough through the counterface. The adhesive friction is due to the sliding friction between diamond and the counterface, which may also be measured according to ASTM D1894 using a smooth diamond surface. In literature, the coefficient of friction between diamond and cast iron is given as 0.1. Therefore the coefficient of abrasive friction μ_{abr} for the example friction coupling was 0.65.

The hardness of the counterface material was calculated according to the following formula:

$$H = \frac{2}{3} Y ( 1 + ln \frac{π E {μ}_{abr}}{6 ( 1 - {v}^{2} ) Y} ) \qquad [ equation 2 ]$$

where
Y is the yield stress of the counterface
E is the elastic modulus of the counterface
v is the Poisson ratio of the counterface.

For cast iron, Y=350 MPA; E=185 GPa and v=0.3

The calculated hardness for the cast iron counterface was 1467 MPa.

By rearranging equation [1] and assuming that ηₘᵢₙ=313, it is possible to calculate the critical pressure of the example friction coupling. The calculated critical pressure is 764 MPa.

In the application for which the friction coupling is intended, the applied pressure is in the region of 200 MPa. Substituting this value in equation [1], the calculated minimum asperity density is 82 asperities per mm².

Thus, for the application in question, a friction surface with fewer diamond particles per unit surface area than the commercially available friction surface may be employed, while ensuring that the high friction coefficient that enhances torque transfer is maintained. In short, a cheaper friction coupling that delivers the same performance can be provided.

The theoretical model which was used to derive equation [1] is based on a number of assumptions. The individual asperities are assumed to be conical in shape and to have the same sharpness angle. Furthermore, a Gaussian distribution in the size and height of the asperities is assumed.

Therefore, when using equation 1 to design a friction surface for a particular friction coupling in an application where a particular pressure is applied on the coupling, a safety factor is preferably employed.

In some embodiments of a friction coupling according to the invention, the asperities on the friction surface are provided in a density η=2.0−2.5*ηₘᵢₙ.

In other embodiments of a friction coupling according to the invention, the asperities on the friction surface are provided in a density η=1.5−2.0*ηₘᵢₙ.

In still further embodiments of a friction coupling according to the invention, the asperities on the friction surface are provided in a density η=1.2−1.5*ηₘᵢₙ.

For the application described above, in which a pressure of approximately 200 MPa is applied on a cast-iron counterface and a friction surface of diamond particles in a Nickel bond layer, a friction coupling according to the invention comprises a friction disk 23 with between 100 and 200 asperities per mm² on its friction surface.

In a further aspect of the invention, the understanding behind equation [1] is used in a method of quality control, to check that a manufactured friction disk, comprising a friction surface provided with hard asperities, is capable of delivering the required high coefficient of friction when subjected to a predefined application pressure P and used in combination with a certain counterface material.

In a first step, the abrasive coefficient of friction μ_{abr} between the friction surface and the counterface is determined. The coefficient of abrasive friction μ_{abr} may be determined by measuring the total friction coefficient between the friction surface and the counterface and subtracting the adhesive coefficient of friction, as described above in the Example.

In a second step, the hardness H of the counterface is determined. Equation [2] may be used to calculate the hardness value or it also possible to use a measured Rockwell C hardness value.

In a third step, at least part of the friction surface is scanned to measure the following parameters:
(i) asperity density η (number of asperities per unit surface area)
(ii) the mean height h̅ of the asperities;
(iii) the standard deviation σ of asperity heights

In a fourth step, equation [1] is used to calculate the minimum threshold for the asperity density

In a fifth step, the calculated minimum asperity density ηₘᵢₙ is compared with the measured asperity density η. If η>ηₘᵢₙ, it is determined that the friction surface is capable of delivering the necessary high coefficient of friction. Preferably, it is determined that the friction surface is capable of delivering the necessary high coefficient of friction if η>X*ηₘᵢₙ, where X is a safety factor with a value of 1.2-2.5.

1. A friction coupling comprising:
a first coupling surface and a second coupling surface, wherein a friction surface is provided on the first coupling surface and a counterface is provided on the second coupling surface; and
preloading means elements adapted to apply a predefined pressure on the first coupling surface and the second coupling surface,
wherein the friction surface is provided with abrasive particles that constitute hard asperities which protrude from a substrate of the friction surface with a height h,
wherein the abrasive particles are provided on the friction surface in an asperity density η, which density is greater than a minimum threshold for the asperity density ηₘᵢₙ and which density η is less than 2.5*ηₘᵢₙ, whereby the minimum threshold is defined by the following relationship:
$${η}_{min} = \frac{π}{4} \frac{P}{H} \frac{{μ}_{abr}^{2}}{{\overline{h}}^{2} + {σ}^{2}}$$
where
η represents number of asperities per unit surface area of the friction surface (m⁻²);
P represents the predefined pressure (Pa);
μ_{abr} represents a coefficient of abrasive friction between the friction surface and the counterface (dimensionless);
H represents a hardness of the counterface (Pa)
h̅ is a mean height of the asperities (m);
σ is the standard deviation of asperity heights (m).

2. The friction coupling according to claim 1, wherein the asperity density η in which the abrasive particles are provided is less than 2.0*ηₘᵢₙ.

3. Friction The friction coupling according to claim 1,
wherein the asperity density i in which the abrasive particles are provided is less than 1.5*ηₘᵢₙ.

4. The friction coupling according to claim 1,
wherein the friction surface is formed by a coating comprising a metal bond layer in which the abrasive particles are embedded.

5. The friction coupling according to claim 4, wherein the metal bond later comprises Nickel,
wherein the abrasive particles comprise one of diamond particles or synthetic diamond particles.

6. The friction coupling according to claim 1, wherein the friction surface is provided on at least one face of an annular friction disk that is mounted to the first coupling surface.

7. The friction coupling according to claim 6,
wherein the annular friction disk is formed from a plurality of segments, each segment having a friction surface.

8. The friction coupling according to claim 1,
wherein the friction surface is provided directly on the first coupling surface.

9. The friction coupling according to claim 1,
wherein the preload means elements are formed by one of a bolt connection, a screw connection or a rivet connection between the first coupling surface and the second coupling surface.

10. A friction disk for use in a friction coupling, the friction coupling comprising:
the friction disk comprising:
a friction surface of abrasive particles embedded in a metal bond layer,
wherein the friction surface has an asperity density η of between 100 and 200 abrasive particles per square millimeter.

11. A method of determining if a friction coupling comprising a friction surface and a counterface will be capable of delivering a desired level of torque transfer when subjected to a predefined operating pressure P, wherein the friction surface is provided with abrasive particles that form hard asperities which protrude from the friction surface with a height h, and wherein the counterface has a hardness H, the method comprising steps of:
a. determining an abrasive coefficient of friction μ_{abr} between the friction surface and the counterface;
b. determining the hardness H of the counterface;
c. measuring the following parameters in at least a region of the friction surface:
(i) the number of asperities per unit surface area, corresponding to an asperity density η;
(ii) the mean height h̅ of the asperities;
(iii) the standard deviation of asperity heights σ;
d. determining that the friction coupling is capable of delivering the desired level of torque transfer if η>ηₘᵢₙ whereby
$${η}_{min} = \frac{π}{4} \frac{P}{H} \frac{{μ}_{abr}^{2}}{{\overline{h}}^{2} + {σ}^{2}} .$$

12. The method of claim 11, the step of determining that the friction coupling is capable of delivering the desired level of torque transfer if η>ηₘᵢₙ further comprising a step of determining that the friction coupling is capable of delivering the desired level of torque transfer in a condition where η>X*ηₘᵢₙ, whereby X is a safely factor.

13. The method according to claim 12, wherein X has a value of between 1.2 and 2.5.

14. The method according to claim 10, wherein the step of determining the hardness H of the counterface further comprising a step of measuring one of a Rockwell C hardness or an equivalent hardness of the counterface.

15. The method according to claim 10, the step of determining the hardness H of the counterface further comprising a step of calculating the hardness of the counterface according to the following formula:
$$H = \frac{2}{3} Y ( 1 + ln \frac{π E {μ}_{abr}}{6 ( 1 - {v}^{2} ) Y} )$$
where
Y is the yield stress of the counterface (Pa)
E is the elastic modulus of the counterface (Pa) and
v is the Poisson ratio of the counterface.
